(19) United States
(12) Patent Application Publication
(10) Pub. No.: US 2016/0265080 A1
(43) Pub. Date: Sep. 15, 2016

(54) METHOD AND APPARATUS FOR INCREASING POROSITY OF METAL BEARING ORE

(71) Applicants: Edward MELCAREK, MacTier (CA); Steven DUNCOMBE, Burlington (CA)

(72) Inventors: Edward MELCAREK, Mactier (CA); Steven Duncombe, Burlington (CA)

(21) Appl. No.: 15/032,413

(22) PCT Filed: Oct. 28, 2013
(86) PCT No.: PCT/CA2013/050815

§ 371 Date: Apr. 27, 2016

(30) Foreign Application Priority Data
Oct. 28, 2013 (CA) PCT/CA2013/050815

(51) Int. Cl. C22B 1/00; B01J 19/08

(52) U.S. Cl. CPC C22B 1/00; B01J 19/087; B01J 2219/0854; B01J 2219/0858

(57) ABSTRACT

A method for increasing the porosity of a metal bearing ore is provided, the method including exposing the metal bearing ore to an oscillating magnetic field, wherein the frequency of oscillation of the oscillating magnetic field is greater than about 0.1 MHz, and preferably about 0.1 MHz to about 1 MHz. The exposure rate of the metal bearing ore to the oscillating magnetic field is greater than about 0.1 T/kg/min. An apparatus is also provided for increasing the porosity of a metal bearing ore.

### FIELD OF THE INVENTION

The present invention generally relates to methods and apparatuses for extracting desired components, such as metals, from ores. In particular, the present invention is related to methods and apparatuses for increasing the porosity of a metal bearing ore to enhance the extraction of the metal(s) contained in the ore.

### BACKGROUND OF THE INVENTION

Gold deposits are often found in silica-based deposits where the gold is in the form of small, microscopic or nanoscale particles that are entrained and/or encapsulated within layers of silica quartz. The gold contained in the ores mined from these types of deposits is generally difficult to extract using conventional methods and processes known in the art.

A common process for extracting gold from a metal bearing ore is cyanidation and heap leaching followed by the Merrill-Crowe process. During heap leaching, crushed ore containing gold is dosed with a leaching solution such as sodium cyanide (NaCN) or potassium cyanide (KCN). Gold and other metals dissolve into such leaching solutions, known as lixiviants, by forming soluble metal-cyanide complexes. The gold “pregnant” leachate is then drained from the heaped ore in a leaching pit, filtered, and then is subjected to the Merrill-Crowe process, wherein zinc is added to the leachate to precipitate dissolved gold out of solution. The precipitated gold is then filtered and further purified as needed.

During heap leaching, the cyanide leaching solution must come into contact with the metals contained in the ore in order for the metals to be dissolved into solution. However, ores containing very small microscopic or nanoscale metal particles that are encapsulated by layers of silica quartz will generally remain un-wetted by the leaching due to the relatively low porosity of the ores because the ore morphology lacks capillary pathways to allow adequate diffusion of the leaching solution to the metal surfaces contained therein. Examples of capillary pathways include, for example, fractures and fissures. Thus, the low “aqueous” porosity caused by the lack of capillary pathways in these ores generally limits gold recovery using the heap leaching process, whether or not followed by the Merrill-Crowe process.

Some attempts have been made at destabilizing the silica matrix surrounding the metals to effectively increase the porosity of the ores. These attempts include heating the ores using microwave radiation or radiant heat, such as with an oven, as well as mechanical crushing of the ores to increase the surface area of the ore material. In one example, U.S. Pat. No. 3,988,036 to Fisher et al. describe inductively heating ore deposits while still in the ground for purposes of metal extraction.

In U.S. Pat. No. 7,459,006 to Ridler, a method is provided for enhancing the extraction of an element from an ore, the method comprising subjecting the ore to pyrolysis using electromagnetic radiation.

In Canadian Patent No. 2,277,383, a method is provided for enhancing the extraction of an element from an ore by subjecting the element bearing material to thermal shock.

In addition, irradiating gold containing ores with high-power electromagnetic pulses for increasing the precious metal recovery is also known and described by Chanturiya et al. (Chanturiya, V. A. et al. (2005); “Application of High-Power Electromagnetic Pulses to Desintegration of Gold-Containing Mineral Complexes”, Pulsed Power Conference, 2005 IEEE: 361-365).

Some of the known methods and processes are generally difficult to implement due to the relatively large energy requirements associated with heating or pyrolyzing the ore in addition to fine particle cone crushing and subsequent handling of the fines.

Thus, there exists a need for a method, process and/or apparatus for increasing the porosity, or “aqueous porosity”, of an ore material that alleviates at least one of the problems known in the art.

### SUMMARY OF THE INVENTION

In one aspect, the present invention provides a method and/or apparatus for increasing the porosity of a metal bearing ore. In one aspect, the invention provides a method wherein a metal bearing ore is exposed to an oscillating magnetic field at an exposure rate sufficient to cause an increase in the porosity thereof. In another aspect, the metal bearing ore is subjected to a magnetic field oscillating at a frequency greater than about 0.1 MHz, and preferably of about 0.1 to about 1 MHz. In another aspect, the exposure rate of the metal bearing ore to the oscillating magnetic field is greater than about 0.1 T/kg/min.

In another aspect, an apparatus for increasing the porosity of a metal bearing ore is provided, the apparatus comprising a magnetic field source configured to generate an oscillating magnetic field, and a conveyor adapted to transport the metal bearing ore through the oscillating magnetic field with an exposure rate sufficient to cause an increase in the porosity thereof. In one aspect, the oscillating frequency of the magnetic field is greater than about 0.1 MHz, and preferably about 0.1 MHz to 1 MHz. In another aspect, the exposure rate of the metal bearing ore to the oscillating magnetic field is greater than about 0.1 T/kg/min.

### BRIEF DESCRIPTION OF THE DRAWINGS

The features of the invention will become more apparent in the following detailed description in which reference is made to the appended drawings, wherein:

FIG. 1A is a diagram schematically illustrating a metal bearing ore being exposed to an oscillating magnetic field according to one embodiment.

FIG. 1B is a diagram schematically illustrating the magnetic field generated by an alternating current flowing through a conductor in the schematic diagram of FIG. 1A.

FIG. 2A is a diagram illustrating the metal in a metal bearing ore being surrounded by minerals prior to exposing the metal bearing ore to an oscillating magnetic field.

FIG. 2B is a diagram illustrating the metal in the metal bearing ore being surrounded by fractured minerals after being exposed to the oscillating magnetic field.

FIG. 3 is a diagram illustrating the method for increasing the porosity of the metal bearing ore according to one embodiment.

FIG. 4 is an apparatus for increasing the porosity of the metal bearing ore according to one embodiment.

FIG. 5A is a diagram schematically illustrating the metal bearing ore being subjected to the oscillating magnetic field according to one embodiment.

FIG. 5B is a diagram schematically illustrating the metal bearing ore being subjected to the oscillating magnetic field according to one embodiment.

FIG. 6A is a cross-sectional view of an apparatus for increasing the porosity of the metal bearing ore according to one embodiment.

FIG. 6B is a top view of the apparatus shown in FIG. 6A.

FIG. 6C is a cross-sectional view of a plurality of apparatuses shown in FIG. 6A operating concurrently.

FIG. 7 is a perspective view of a magnetic field generator according to one embodiment.

FIG. 8 is a circuit diagram of the magnetic field generator connected to a power source in one embodiment.

FIG. 9 is a current profile obtained at the electrical conductor in the circuit diagram shown in FIG. 8.

FIG. 10 is a plot showing the maximum gold recovery percentage obtained for samples exposed at various frequencies in one example.

FIG. 11 is a gold leaching kinetics plot obtained for samples exposed at various frequencies in one example.

### DETAILED DESCRIPTION OF THE INVENTION

The terms “comprise”, “comprises”, “comprised” or “comprising” may be used in the present specification. As used herein (including the disclosure and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

The term “conveyor” as used herein is intended to mean a device or apparatus that serves to transfer a material from one location to another. In one example, the conveyor may be a conveyor belt, which transports material on a surface thereof. In another example, the conveyor may be a conduit, such as a pipe or the like, through which material is moved. The movement of the material through the conduit may be effected using any force, including pumps and/or gravity.

The term “aqueous porosity” as used herein is intended to mean a porosity that is sufficient to allow penetration and diffusion of a liquid solution.

In one aspect, the present invention provides a method for increasing the porosity, or “aqueous” porosity, of a metal bearing ore, the method comprising exposing the metal bearing ore to an oscillating magnetic field. The magnetic field preferably oscillates at a frequency of greater than about 0.1 MHz, and preferably about 0.1 MHz to about 1 MHz. The exposure rate of the metal bearing ore to the magnetic field is preferably greater than about 0.1 T/kg/min. More preferably, the magnetic field oscillates at a frequency of about 250 to about 350 kHz. In one embodiment, the magnetic field oscillates at a frequency of about 330 kHz. In one aspect, the invention provides a “non-thermal” method of increasing the aqueous porosity of the metal bearing ore, in that the method does not require heating of the metal bearing ore.

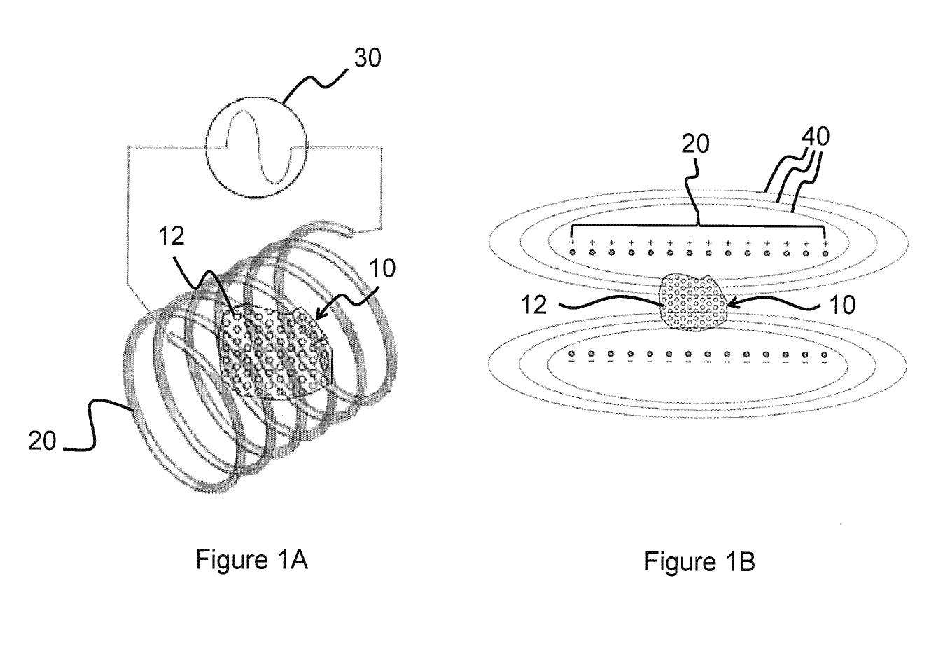

The method according to one embodiment of the invention is illustrated in FIGS. 1A and 1B, where a metal bearing ore 10 is illustrated as being exposed to a magnetic field 40 generated by a current flowing through an electrical conductor 20. In FIG. 1A, the electrical conductor 20 is illustrated as being connected to a power source 30, which causes an alternating current to flow through the electrical conductor 20. For example, the current flowing through the electrical conductor 20 may be a sinusoidal alternating current or any other form of alternating current. As will be understood by persons skilled in the art, the current flowing through the conductor will generate a magnetic field, illustrated by magnetic field lines 40 in FIG. 1B.

As illustrated in FIGS. 1A and 1B, the metal bearing ore 10 contains a number of metal particles and/or metal clusters 12. For the sake of simplicity, metal particles and/or metal clusters 12 will simply be referred to herein as the metal particles 12. The metal particles 12 may be of the same element or of different metallic elements. For example, the metal bearing ore 10 may comprise gold and/or iron or a mixture of such metals along with other metals. It will be understood that the present invention is not limited to any particular metal or metals. However, the invention is particularly suited for application to gold bearing ores. Generally, the metal particles 12 are surrounded by minerals such as silica, which, as described above, inhibits the leaching solutions from contacting the metal particles 12 during the metal extraction process. In some cases, the metal particles 12 may be completely encapsulated between layers of silica quartz.

It is generally well known that some metals, such as iron, display ferromagnetism, and as such, are affected by changes in the external magnetic field. It has also been shown by Luo et al. (Weidong Luo et al. (2007); “s-Electron Ferromagnetism in Gold and Silver Nanoclusters”, Nano Letters, 7(10): 3134-3137) that nanoclusters of gold also exhibit ferromagnetic behaviour, and are therefore responsive to changes in the external magnetic field. It has been observed that iron particles as well as gold nanoclusters can be present in ores mined from some silica-based deposits. Based on these previous findings, the inventors postulated that exposure of these metal-containing ores to a magnetic field, in particular an oscillating, or reversing magnetic field, will induce vibration of the metal particles 12, which would in turn apply a force against the surrounding mineral component of the ore. This force would be generated as a result of the metal particles 12 vibrating in response to the oscillation of the magnetic field, such as would be expected in accordance with the Lorentz force law. It will be appreciated that, unlike the metal particles 12, the minerals surrounding the metal particles 12 (e.g. silica quartz matrices) are not magnetic, and therefore will not respond to the externally applied magnetic field. The vibration of the metal particles would thereby generate fractures and/or fissures in the surrounding mineral component, thereby increasing the aqueous porosity of the latter. In such state, the ore would be more effectively treated with a leaching solution to dissolve and extract the metal or metals contained therein.

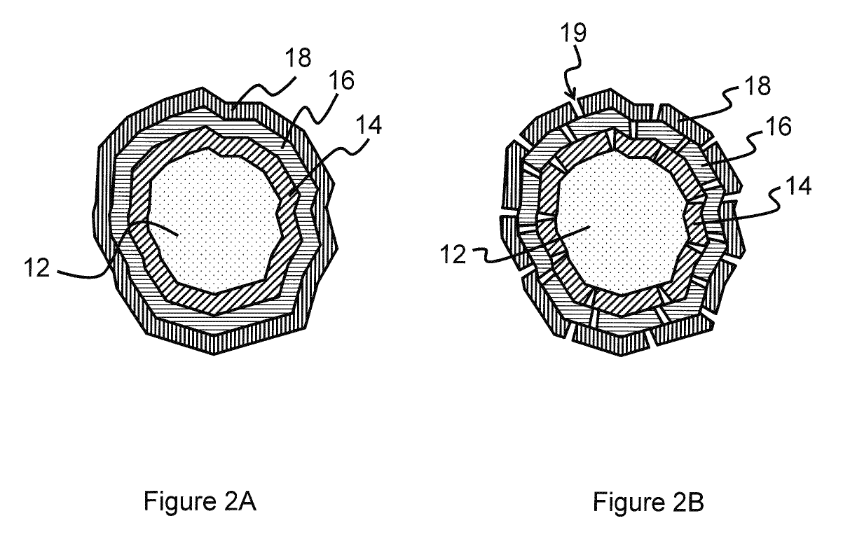

It will be appreciated that in an oscillating magnetic field, the polarity of the magnetic field is reversed every half-cycle. For greater clarity, a half-cycle is understood to be a time period that is half of the period of oscillation of the magnetic field. As explained above, the oscillating magnetic field causes the metal particles 12 to periodically apply vibratory forces against the minerals surrounding the metal particles 12. The vibratory forces applied by the metal particles 12 stress the surrounding minerals, and over time, lead to formation of micro-fractures and/or fissures in the surrounding minerals. The formation of micro-fractures and/or fissures increase the overall porosity of the metal bearing ore, thus enhancing the effectiveness of the metal extraction processes. For example, creation of the aforementioned fractures and/or fissures will allow more of the metal to be exposed to leaching solutions, thereby improving the metal recovery efficiency. The micro-fractures and fissures formed according to the method of the present invention are schematically illustrated in comparing FIGS. 2A and 2B. The metal particle 12 is shown in FIG. 2A as being surrounded by layers of silica quartz 14, 16, 18 prior to being exposed to the oscillating magnetic field. However, as shown in FIG. 2B, once the metal particle 12 has been exposed to the oscillating magnetic field according to the methods and/or apparatuses of the present invention, the layers of silica quartz 14, 16, 18 will contain various fractures or fissures 19 formed therein due to the vibration of the metal particles 12.

Preferably, the exposure rate of the metal bearing ore to the oscillating magnetic field is greater than about 0.1 T/kg/min. In other words, as will be understood, the magnetic flux density of the oscillating magnetic field would be adjusted in accordance with the mass flow rate of the gold bearing ore passing through the field. It will be understood that, for example, 1 kilogram of gold bearing ore may be exposed to an oscillating magnetic field having a magnetic flux density of about 0.1 Tesla for approximately 1 minute in accordance with the methods and/or apparatuses of the present invention to increase the porosity of the metal bearing ore. For greater clarity, the exposure time as used herein will be understood to be the time period for which the metal bearing ore is exposed to the oscillating magnetic field.

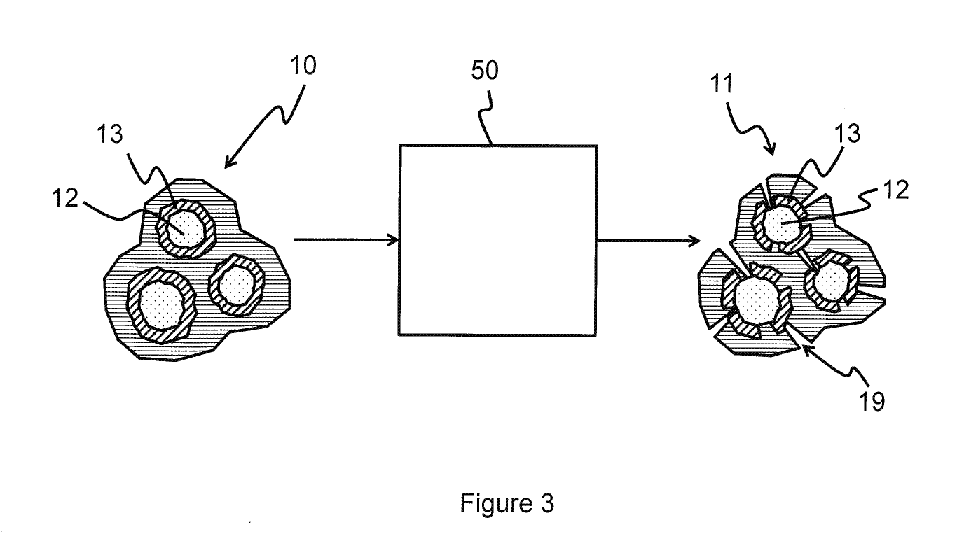

In one embodiment, the method may be performed by transporting the metal bearing ore through the oscillating magnetic field as schematically illustrated in FIG. 3. Typically, an ore to be treated is first crushed using known methods and apparatuses to break or comminute the ore into smaller fragments. In accordance with the present invention, the crushed metal bearing ore 10 is then treated by exposing the ore to an oscillating magnetic field. Such exposure is generally done by transporting the metal bearing ore 10 through a treatment area 50 where the magnetic field is generated. The oscillating magnetic field may be generated, for example, by a current-carrying conductor. As explained above, exposing the metal bearing ore 10 to the oscillating magnetic field causes micro-fractures and/or fissures 19 to form within the mineral 13 surrounding the metal particles 12, thereby increasing the porosity of the ore particles. The treated ore particles, 11, may then be further processed using conventional methods, such as leaching etc., to recover the metal or metals therefrom. It has been found that exposing the metal bearing ore 10 to the oscillating magnetic field, according to an aspect of the present invention, significantly increased the rate of gold recovery from the metal bearing ore. This finding is described further in the examples below.

In one aspect, the invention provides an apparatus for increasing the porosity of a metal bearing ore. The apparatus comprises a magnetic field source configured to generate an oscillating magnetic field and a conveyor adapted to transport the metal bearing ore through the oscillating magnetic field. As will be understood, such a configuration of the apparatus provides a continuous treatment process. It also be understood that the method of the invention may equally be conducted in a batch manner, in which case the conveyor may be omitted. In a further aspect, the frequency of oscillation of the oscillating magnetic field is about 0.1 MHz to about 1 MHz. Generally, the apparatus of the invention is adapted to expose the metal bearing ore to an oscillating magnetic field at a rate of at least about 0.1 T/kg/min.

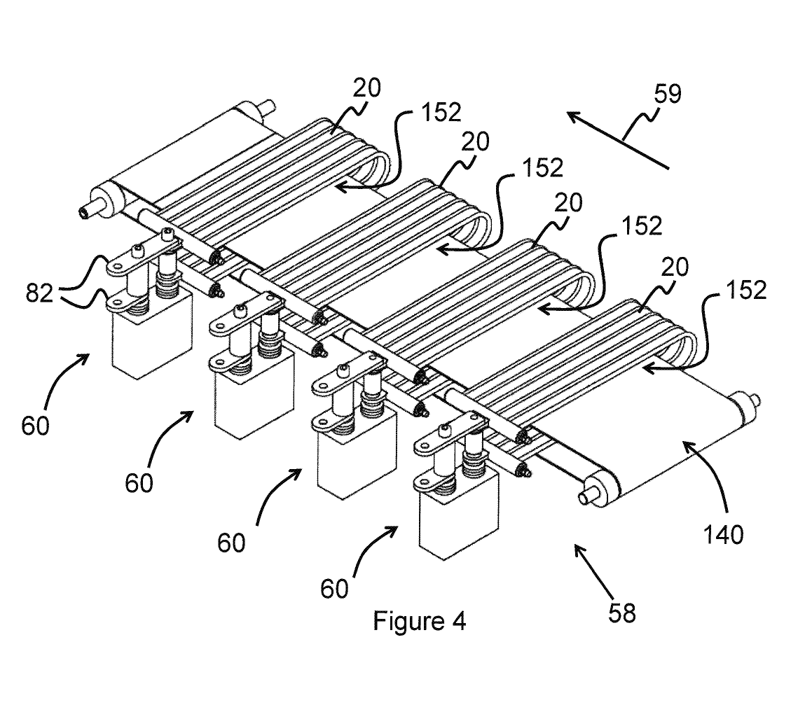

One embodiment of the apparatus of the invention is illustrated in FIG. 4. As shown, the apparatus 58 comprises a conveyor, such as a conveyor belt 140, for transporting the metal bearing ore (not shown), and at least one magnetic field generator 60. It will be understood that the “conveyor” of the apparatus generally comprises any means or device that serves to transport the ore. The embodiment illustrated in FIG. 4 is preferred as conveyor belts and the like are commonly used in ore treatment processes. However, the conveyor may also comprise a conduit through which the ore material to be treated can be passed or flowed using a driving force. Such driving force may be gravity or achieved by one or more pumps or pumping systems. An example of such a conduit is described below.

In the preferred embodiment, each magnetic field generator 60 is configured to generate an oscillating magnetic field. The purpose or advantage of using an oscillating magnetic field was described above. The apparatus is arranged such that the metal bearing ore is transported by the conveyor, such as the conveyor belt 140, through the oscillating magnetic field. Thus, the conveyor allows untreated ore to pass through a treatment zone where the ore is exposed to the magnetic field and converted to a treated ore. In FIG. 4, the direction of transport of the conveyor belt 140 is indicated by the arrow 59.

FIG. 4 also illustrates a preferred embodiment wherein a plurality of magnetic field generators 60 is shown. As will be understood, the use of multiple magnetic field generators allows for a faster processing time for the ore. In the preferred embodiment, the magnetic field generator 60 generally comprises a conductor 20 connected to a power source (not shown), which generates an alternating current. The generated current flows through the conductor 20 to generate the oscillating magnetic field, as would be understood by persons skilled in the art. In one embodiment, one or more, and preferably a plurality (i.e. greater than one), magnetic field generators 60 are provided and are arranged linearly and adjacent to the conveyor belt 140 as shown in FIG. 4. Although the power source is not shown in the figures, it will be appreciated that the magnetic field generators 60 may be connected to the power source through electrodes 82 in any number of ways. For example, all of the magnetic field generators 60 may be connected to a common power source or, alternatively, each magnetic field generator 60 may be provided with a separate power source to create redundancy. In a preferred embodiment, the oscillating magnetic field is generated using an alternating current. In such case, since the oscillation of the magnetic field is correlated to the alternating current, the power source is preferably adapted to generate an alternating current oscillating at a frequency of about 0.1 to about 1 MHz.

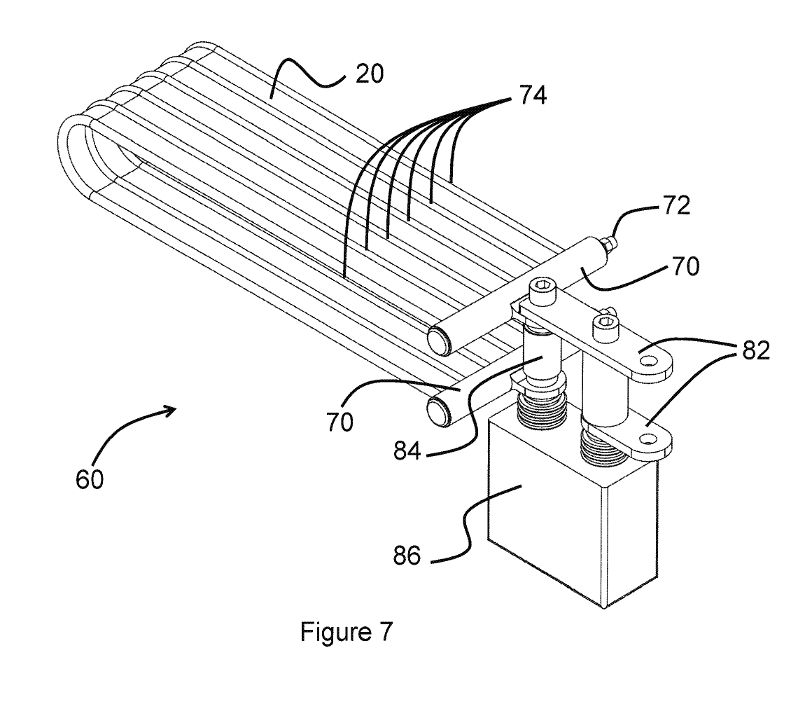

One embodiment of a magnetic field generator 60 for use in the methods and/or apparatuses described herein is shown in FIG. 7. As shown, the magnetic field generator 60 comprises an electrical conductor 20, connected to a power source (not shown) using a pair of electrodes 82 to flow an alternating current through the electrical conductor 20 to generate an oscillating magnetic field. In the embodiment shown in FIG. 7, the conductor 20 is a planar or plate conductor folded into a generally U-shaped or loop structure. In such arrangement, a space 152 is formed between the folded arms of the conductor 20. In one embodiment, as illustrated in FIG. 4, the conveyor belt 140 is adapted to pass through the spaces 152 of the conductors 20. As will be understood, in this manner, the ore supported on the conveyor will be subjected to a magnetic field on all sides as it passes through the spaces 152 of the conductors.

Although the electrical conductor 20 is generally shown as being a planar or plate conductor, it will be appreciated that the conductor may take on any other shapes or configurations. For example, the conductor may be wounded to form a solenoid. However, it will be understood that increasing the number of turns or loops in such conductor configurations will result in increased inductance and therefore greater resistivity. As such, in order to minimize the resistivity and power loss, the electrical conductor 20 preferably only forms one loop as shown in FIG. 7, for example.

According to one embodiment, in operation, the metal bearing ore is positioned on the conveyor belt 140 upstream from the magnetic field generators 60. The metal bearing ore is then transported downstream in the direction indicated by the arrow 59 through the oscillating magnetic field generated by the magnetic field generators 60. In the embodiment shown in FIG. 4, it will be appreciated that the magnetic flux density of the oscillating magnetic field will generally be the greatest within the space 152 formed by each of the looped conductors 20 of the magnetic field generators 60. Therefore, in one embodiment, the conveyor belt 140 passes through the looped conductors 20, such that the metal bearing ore is transported through the space 152 to be treated by exposure to the oscillating magnetic field.

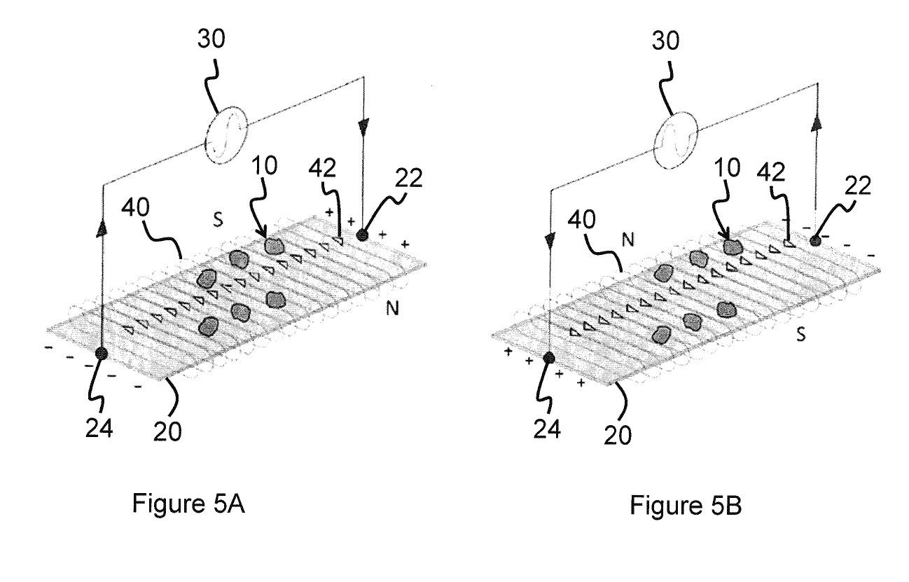

The interactions between the magnetic field created by the current flowing through the electrical conductors 20 and the metal bearing ore 10 are schematically illustrated in the FIGS. 5A and 5B. In FIG. 5A, the current is shown as flowing from a first terminal 22 to a second terminal 24 through the electrical conductor 20, thereby generating a magnetic field 40 in the direction indicated by the arrows 42. However, since the current flowing through the electrical conductor 20 is an alternating current, the direction of the current is reversed every half-cycle (i.e. half of the period of oscillation). As shown in FIG. 5B, when the direction of the current is reversed such that the current is flowing from the second terminal 24 to the first terminal 22 through the electrical conductor 20, the direction of the magnetic field 40 is also reversed as indicated by the arrows 42. As described above, this periodic reversal of the direction or polarity of the magnetic field 40 causes the metal particles present within the metal bearing ore 10 to vibrate and thereby apply a force against the surrounding mineral components. After exposure to the magnetic field, the mineral surrounding the metal particles becomes destabilized, thereby leading to formation of micro-fractures and/or fissures in the mineral and thereby increasing the porosity of the ore 10. As discussed above, such increase in porosity allows a leaching solution, as commonly known in the art, to contact the metal component of the ore, thereby allowing enhanced or increased extraction thereof.

It will be appreciated that the conveyor belt 140 may generally comprise non-conductive components to avoid inductive coupling and thereby avoid heating thereof. For example, the conveyor belt 140 may be made of a conventional fiberglass woven material.

As will be understood, due to the current flowing through the conductor 20, heat will be generated. In situations where the ambient conditions may result in overheating of the conductors 20, the apparatus of the invention provides a cooling system, which is illustrated in FIG. 7. Specifically, in one embodiment, the magnetic field generator 60 preferably includes one or more cooling ports 72, connected to a manifold 70. The manifold is fluidly connected to a plurality of coolant conduits or veins 74 extending along the body of the conductor 20 as illustrated in FIG. 7. The cooling ports 72, manifold 70 and veins 74 are used to circulate a coolant through the conductor 20 during operation. As will be understood, the circulating coolant serves to dissipate the heat generated by the conductor 20. The coolant may be, for example, a liquid coolant such as water, although it will be understood that the invention is not limited to any type of coolant.

In one aspect, the magnetic field generator 60 may further comprise at least one capacitive component and at least one inductive component. These circuit components may be connected in parallel and/or series configuration. By way of example, a tuning capacitor 84 and a coupling capacitor 86 are shown in FIG. 7, which are generally used for purposes of impedance matching to increase the efficiency of power transfer.

It will be appreciated that the method as described above may be performed as a continuous process, wherein a crushed metal bearing ore is continuously fed onto the moving conveyor belt 140 to be transported through the oscillating magnetic field, at a predetermined speed, and collected downstream. It will also be appreciated that the speed at which the conveyor belt 140 transports the metal bearing ore and/or the magnetic flux density of the oscillating magnetic field generated by the magnetic field generator 60, may be varied appropriately to obtain the desired exposure rate. Preferably, the exposure rate of the metal bearing ore to the oscillating magnetic field is greater than about 0.1 T/kg/min.

Although the apparatus has been described and shown as generally transporting the metal bearing ore in a substantially horizontal direction, it will be appreciated that the treatment may be performed while transporting the metal bearing ore in any other orientation, such as in an inclined or declined orientation. The invention is not limited to any orientation of the conveyor.

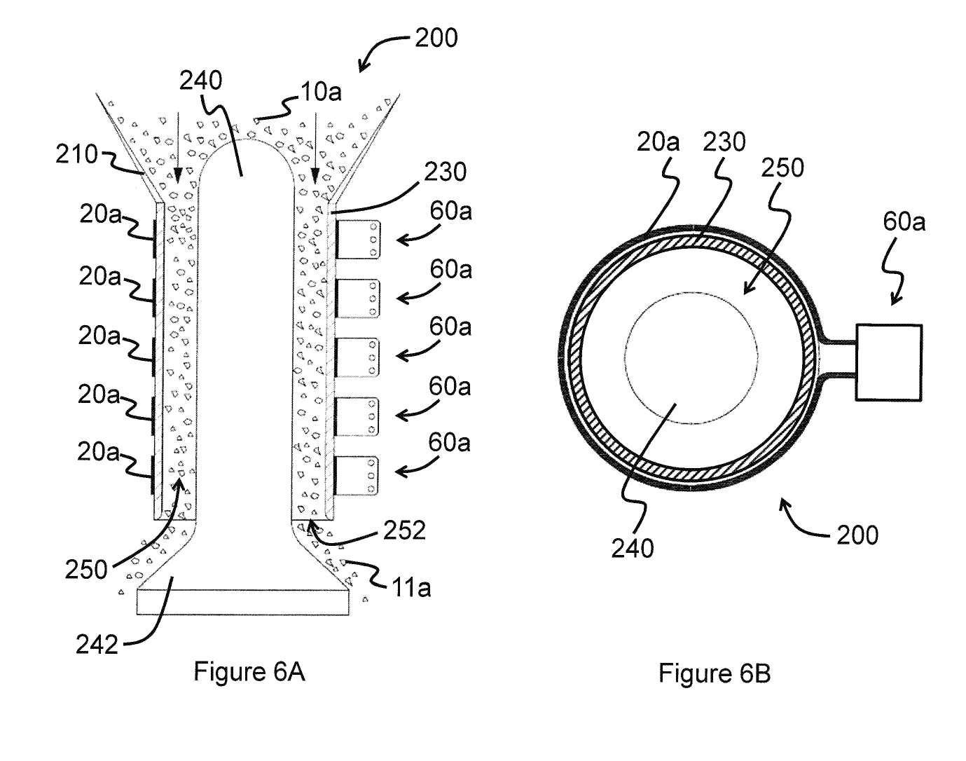

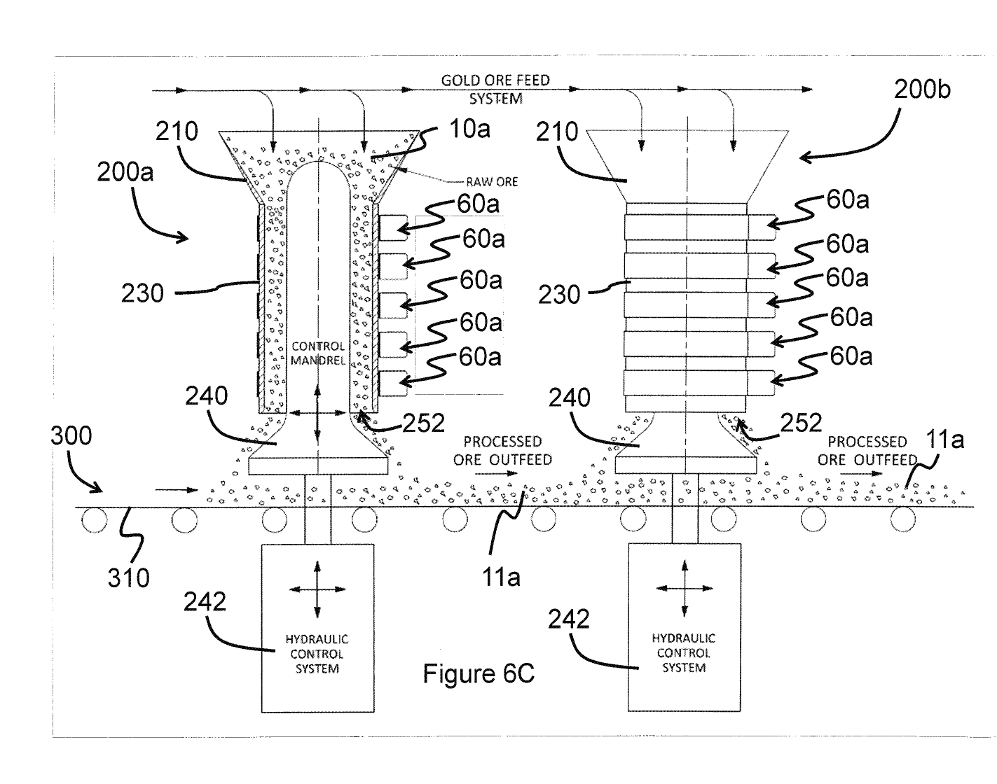

As mentioned above, in one embodiment, the metal bearing ore may be transported through a conduit instead of by a conveyor belt. FIG. 6A shows one embodiment of an apparatus 200 wherein the conveyor comprises a conduit 230, such as a tube or a pipe as would be commonly known in the art. In FIG. 6A, elements similar to those described previously are identified with the same reference numeral but with the letter “a” added. As shown in FIG. 6A, the metal bearing ore 10a is transported vertically through the conduit 230.

As also shown in FIG. 6A, one or more oscillating magnetic field generators 60a are provided along at least a portion of the length of the conduit 230, i.e. generally parallel to the longitudinal axis of the conduit. According to one embodiment, each magnetic field generator 60a comprises a conductor 20a connected to a power source (not shown), the power source generating an alternating current, which is adapted to flow current through the conductor 20a to generate an oscillating magnetic field. FIG. 6B further illustrates the conductor 20a. As shown, the conductor 20a comprises a generally circular loop that surrounds at least a portion of the circumference of the conduit 230. As will be understood, the conductor 20a thereby generates a magnetic field through the lumen of the conduit 230.

In the embodiment shown in FIG. 6A, the conduit 230 is further provided with a generally centrally positioned mandrel 240 that is coaxially arranged with the conduit 230. The mandrel has an outer diameter that is smaller than the inner diameter of the conduit 230. In such arrangement, and as illustrated in FIGS. 6A and 6B, an annular space 250 is formed between the hollow conduit 230 and the mandrel 240.

As will be understood, the mandrel 240 serves to prevent blockage of the ore material as it passes through the conduit 230. In one aspect of the invention, the mandrel 240 is adapted to vibrate or shake while the hollow conduit 230 remains stationary. The movement of the mandrel 240 results in agitation of the ore stream and thereby reduces the likelihood of the material becoming jammed within the conduit 230. The mandrel 240 may be connected to, for example, a hydraulic control system 242 as shown in FIG. 6C, which causes the mandrel 240 to vibrate or shake. In one embodiment, the mandrel 240 may further be adapted to modulate the flow rate of metal bearing ore through the hollow conduit 230. For example, in the embodiment shown in FIG. 6A, the mandrel 240 is shown as having a flared portion 242 near the outlet 252 of the conduit 230. As shown in FIG. 6A, due to the presence of the mandrel 240, the outlet 252 assumes a generally annular profile. Thus, the size of the outlet 252 is determined by the annular gap formed between the hollow conduit 230 and the mandrel 240. In particular, the mandrel 240 may be positioned such that the size of the outlet 252 approximately corresponds to the gap between the flared portion 242 of the mandrel 240 and the hollow conduit 230. In such cases, when the mandrel 240 is displaced upwards, the size of the outlet is reduced. Similarly, when the mandrel 240 is displaced downwards, the size of the outlet is increased. As will be understood, the flow rate of the metal bearing ore 10 being transported through the hollow conduit 230 would then be controlled by adjusting the size of the outlet 252 by raising or lowering the mandrel 240. For example, a larger outlet allows increased flow of the metal bearing ore and thus decreases the exposure time, whereas a smaller outlet decreases the flow and thus increases the exposure time. Therefore, the flow rate, and thus the exposure time of the metal bearing ore being transported through the hollow conduit 230 can be modulated by vertically displacing the mandrel 240 to change the size of the outlet 252.

According to one embodiment of the invention as illustrated in FIG. 6C, the metal bearing ore 10a is fed into the apparatus 200 through a hopper 210, which may be located near the top of the apparatus 200 in cases where the conduit or conduits 230 are generally vertically oriented. It will be understood that the conduits can be arranged in any orientation. In the embodiment illustrated in FIG. 6C, a pair of apparatuses, both indicated at 200, is illustrated, with the apparatus on the left shown schematically in cross section. It will be understood that the invention is not limited to any number of such apparatuses. The metal bearing ore 10a is transported through the conduits towards the bottom of each apparatus 200 by the force of gravity. In other embodiments, the ore material may be pumped through the conduit 230 of the apparatus 200. While the metal bearing ore 10a is transported, it is exposed to the oscillating magnetic field generated by the magnetic field generators 60a. As described above, the flow rate of the metal bearing ore 10a may be controlled by adjusting the position of the mandrel 240. As discussed above, the flow rate of the ore is preferably adjusted so as to allow an exposure rate of the ore to the magnetic field of at least about 0.1 T/kg/min. The treated metal bearing ore 11a is then dispensed from the outlet 252 located at or near the bottom of the hollow conduit 230.

As shown in FIG. 6C, the metal bearing ore 10a is fed into each apparatus 200 to be treated by exposure to the oscillating magnetic field as described above. The treated metal bearing ore 11a is dispensed from the outlet 252 of each apparatus 200 onto an ore outlet system 300. The ore outlet system 300 may, for example, comprise a conveyor belt 310 for carrying the treated metal bearing ore 11a away from the apparatus 200 for further transportation, storage and/or processing of the treated metal bearing ore 11a.

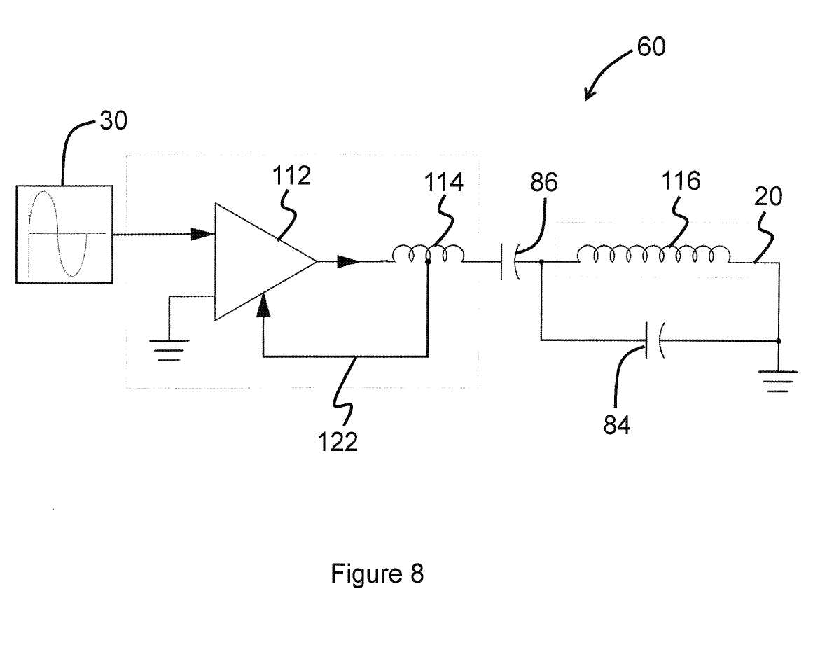

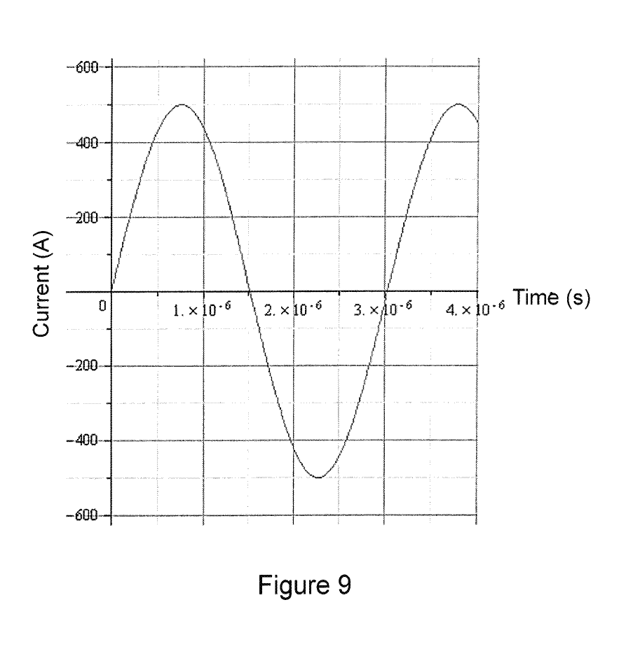

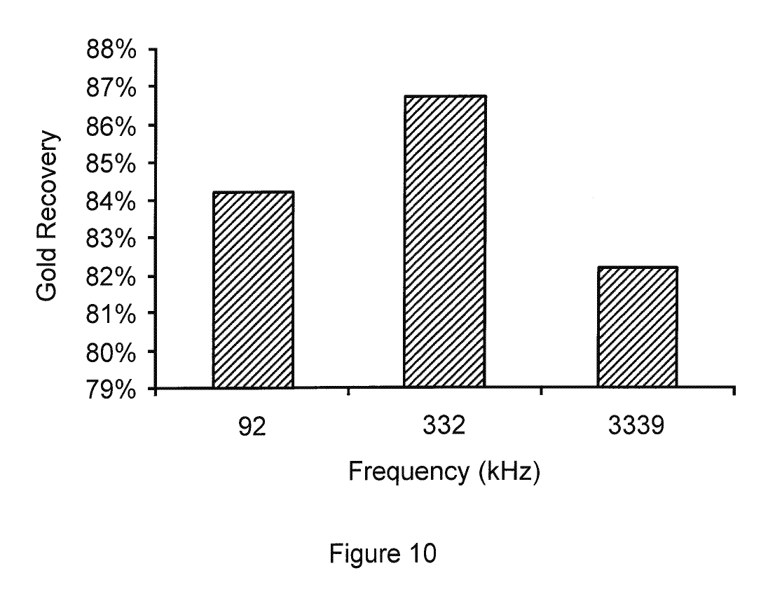

FIG. 8 shows a simplified electrical circuit diagram of the magnetic field generator 60 according to one embodiment, and FIG. 9 shows the current response obtained at the conductor 20 in the circuit shown in FIG. 8. In one embodiment, the power source 30 is adapted to generate an alternating current oscillating at a frequency of about 0.1 MHz to about 1 MHz. The alternating current may be, for example, a sinusoidal alternating current. As shown in FIG. 8, the output of the power source 30 is connected to an amplifier 112, which amplifies the amplitude of the signal transmitted from the power source 30. According to one embodiment, the amplifier 112 may be a conventional class C amplifier, which may be a triode, tetrode, or a solid-state amplifier. The output of the amplifier 112 is connected to a coupling capacitor 86 via a coupling inductor 114. As shown in FIG. 8, the coupling capacitor 86 is connected to a LC tank circuit comprising an inductor 116 and the tuning capacitor 84 connected in parallel configuration. A feedback loop 122 is also present in the embodiment shown in FIG. 8 for providing the amplifier 112 with a voltage feedback from the coupling inductor 114. The feedback loop 122 generally enables the amplifier 112 to turn on or off depending upon the voltage level detected at the coupling inductor 114.

FIG. 9 shows the current response obtained at the conductor 20 or 20a in the circuit shown in FIG. 8 according to one embodiment. As will be understood by persons skilled in the art, the frequency of the oscillation of the current flowing through the conductor 20 or 20a will dictate the oscillation frequency of the magnetic field. In FIG. 9, a sinusoidal alternating current oscillating at a frequency of approximately 333 kHz is shown by way of example.

Although various aspects and embodiments have been described with reference to iron and gold as examples, it will be understood that the methods and apparatuses described herein may be similarly applied to metal bearing ores comprising various other metals and/or metal complexes.

It will be appreciated that the metal bearing ore may be crushed prior to being exposed to the magnetic field in various aspects and embodiments described herein. As such, the metal bearing ore as used herein may comprise a plurality of metal bearing ore fragments. Furthermore, it would be apparent to persons skilled in the art that the metal bearing ore may be crushed in any number of ways.

Furthermore, it will be appreciated that different features of various embodiments of the method and apparatus, as described herein, may be combined with one another in any number of ways. In other words, for example, different frequencies and device configurations described in relation to one embodiment may similarly be applied to other embodiments described herein, although not specifically stated.

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

Aspects of the invention will now be illustrated with reference to the following examples. It will be understood that the scope of the invention is not to be limited by the examples.

### EXAMPLES

A number of tests were conducted to determine the effectiveness of the method for increasing the porosity of the metal bearing ore. The tests were generally performed by taking crushed metal bearing ore samples having an average diameter of approximately 32 mm and exposing the crushed metal bearing ore samples to an oscillating magnetic field. As shown in Table 1 below, factors such as the exposure time, the frequency of oscillation of the magnetic field, as well as the power of the current used to generate the oscillating magnetic field were varied between each sample.

Table 1 summarizes the results obtained from a series of direct bottle roll cyanide leaching tests that was performed on Veladero™ Type I metal bearing ore samples. As previously mentioned, the metal bearing ore samples were first prepared by mechanically crushing the ore until an average diameter of approximately 32 mm was reached. The crushed ore samples were then each exposed to the oscillating magnetic field in accordance with the parameters noted in Table 1. It is noted that the crushed ore samples were all treated by placing each metal bearing ore sample in a 500 mL Pyrex® beaker and subjecting it to an oscillating magnetic field generated by an alternating current flowing through a conductor wrapped around the beaker.

The treated metal bearing ore samples were then placed in a container along with sodium cyanide (NaCN) solution. It is also noted that for each sample, the pulp density was adjusted to 35% solids with water. Furthermore, 200 g/L lime slurry was used to maintain the pH of the solution at approximately 11. The level of cyanide was maintained at 1 g/L. All bottle roll leaching tests were performed at ambient temperature, and the samples were all rolled for a period of 13 days to determine the leaching kinetics and the final gold recovery percentages.

During the tests, samples of leached solution were taken every 24 hours from each bottle for the purpose of analysing the leaching kinetics. At the end of the testing, the contents of each bottle were filtered to obtain a filtrate and a retentate. The filtrate and the washings (i.e. the retentate) were collected from each bottle and analyzed separately. In particular, the washed retentate was dried, weighed and crushed until the average diameter was approximately 2 mm, and then further pulverized until 90% of the pulverized retentate had a diameter of less than approximately 75 μm. The pulverized retentate was then analyzed for metal content.

In Table 1, treatment parameters including the exposure time in seconds, the frequency of oscillation of the magnetic field in kHz, and the power of the current used to generate the magnetic field in kW are listed for each sample. Additionally, the calculated head grade of gold and the residue grade of gold, which represent the amount of gold in grams present per one ton of ore before leaching and after leaching, respectively, are shown for each sample. Percentage recovery of gold was calculated by dividing the amount of gold recovered from each sample using the Merrill-Crowe process by the total amount of gold contained in the control sample (i.e. the calculated head grade of the control sample). Furthermore, the temperature gain observed in each sample following the exposure to the magnetic field was recorded. The temperature gain for each sample was determined by taking the difference between the temperatures of the ore surface before the treatment and immediately after the treatment. The surface temperatures of the treated ore samples were measured using an IR laser thermometer.

TABLE 1
Cyanide Leaching Test Results

| | Treatment Parameters | | | Calculated | Residue | Calculated | Temperature |
|---|---|---|---|---|---|---|---|
| Sample | Exposure | Frequency | Power | Head Grade, | Grade, | Recovery, | Gain |
| No. | Time (s) | (kHz) | (kW) | Au (g/t) | Au (g/t) | Au (%) | (° C.) |
| 1 | 0 | N/A | N/A | 2.47 | 0.63 | 69.6% | N/A |
| 2 | 60 | 3339 | 3 | 2.43 | 0.46 | 82.2% | 2.7 |
| 3 | 30 | 3339 | 1 | 2.25 | 0.61 | 70.3% | 0.5 |
| 4 | 30 | 3339 | 1.5 | 2.71 | 0.57 | 76.3% | 1.0 |
| 5 | 30 | 3339 | 2 | 2.50 | 0.51 | 78.8% | 1.1 |
| 6 | 30 | 3339 | 3 | 2.75 | 0.55 | 79.5% | 0.9 |
| 7 | 15 | 3339 | 4 | 2.73 | 0.54 | 78.3% | 0.8 |
| 8 | 90 | 92 | 21.3 | 3.76 | 0.55 | 82.0% | 8.5 |
| 9 | 60 | 92 | 21.3 | 3.79 | 0.47 | 84.2% | 7.6 |
| 10 | 30 | 92 | 21.3 | 2.78 | 0.51 | 76.9% | 5.1 |
| 11 | 20 | 92 | 21.3 | 2.83 | 0.51 | 79.9% | 2.0 |
| 12 | 12.5 | 92 | 21.3 | 3.78 | 0.56 | 82.8% | 5.6 |
| 13 | 10 | 92 | 21.3 | 4.04 | 0.86 | 75.2% | 1.9 |
| 14 | 60 | 332 | 4 | 4.19 | 0.49 | 86.7% | 2.0 |
| 15 | 40 | 332 | 4 | 3.64 | 0.56 | 83.2% | 1.0 |
| 16 | 20 | 332 | 4 | 3.49 | 0.51 | 81.9% | 0 |
| 17 | 10 | 332 | 4 | 2.79 | 0.55 | 81.1% | 0 |
| 18 | 5 | 332 | 4 | 2.84 | 0.47 | 83.3% | 0 |
| 19 | 5 | 332 | 4 | 2.81 | 0.51 | 81.3% | 0 |

In total, 19 samples were subjected to the cyanide leaching tests. The mass of each sample ranged from about 400 to 640 grams. It is noted that ore sample 1 is a control sample, meaning that it was not subjected to a magnetic field treatment.

FIG. 10 is a graph showing the highest gold recovery percentage obtained from exposing the samples to each of the three different magnetic field frequencies (i.e. 92 kHz, 332 KHz, and 3339 KHz). More specifically, the percentage of gold recovery shown on the graph is the highest percentage of gold recovery obtained out of all of the samples that were exposed at each of the three frequencies. These samples were determined to be samples 2, 9 and 14. As it can be seen from FIG. 10, the highest percentage of gold recovery was obtained from processing the ore sample that was exposed to 332 kHz magnetic field (i.e. sample 14), followed by the ore sample exposed to 92 kHz magnetic field (i.e. sample 9). The lowest percentage of gold recovery was obtained from processing the ore sample that was exposed to 3339 kHz (i.e. sample 2).

Furthermore, it is apparent from comparing the gold recovery percentage of the exposed samples to that of the control sample (i.e. sample 1) that gold recovery was increased by up to about 17% when the metal bearing ore was subjected to 332 kHz magnetic field. Similarly, gold recovery was increased by up to about 15% and 13% for samples exposed to 332 kHz magnetic field and 3339 kHz magnetic field, respectively.

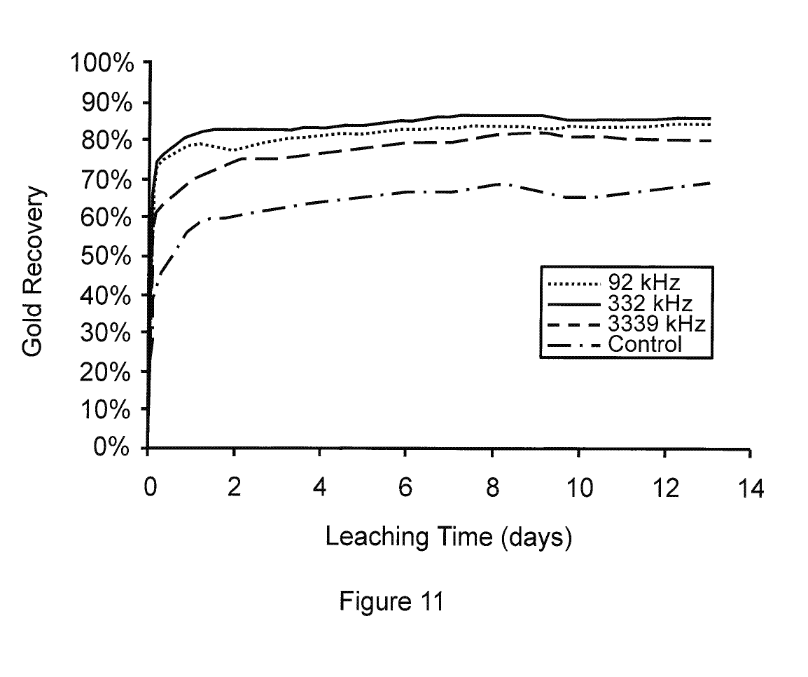

The above observations are further supported by the leaching kinetics data shown in the plot of FIG. 11. The leaching kinetics data in FIG. 11 was plotted by analyzing the amount of gold that had been dissolved into the solution by the end of each day of bottle rolling. Although no significant changes in the rate of gold dissolution were observed between the samples, it is clear that the percentage of gold recovery was the highest for the sample exposed to 332 kHz magnetic field followed by the sample exposed to 92 kHz magnetic field for all of the days. Although some improvement in the percentage of gold recovery was observed for the sample exposed to 3339 kHz magnetic field in comparison to the control sample (i.e. sample 1), it is clear that other samples which were exposed to lower magnetic field frequencies showed higher percentages of gold recovery. Furthermore, as is known in the art, magnetic fields are generally attenuated to some degree due to the presence of various mediums, such as air and ore. It is also known that the degree of attenuation can depend on factors such as the frequency of oscillation of the magnetic field as well as the characteristics of the medium(s). Specifically in relation to the present invention, it has been observed that the degree of attenuation is significantly higher for magnetic fields oscillating at frequencies above 1 MHz compared to those oscillating at frequencies of or below 1 MHz when ores are present within the magnetic fields. As such, the magnetic field preferably oscillates at about 0.1 MHz to 1 MHz to reduce the degree of attenuation, thereby allowing a more uniform treatment of the metal bearing ore. However, it will be appreciated that the degree of attenuation may also vary with other factors such as the iron content of the ore.

1. A method for increasing the porosity of a metal bearing ore, the method comprising exposing the metal bearing ore to an oscillating magnetic field, wherein:
the frequency of oscillation of the oscillating magnetic field is greater than about 0.1 MHz; and,
the exposure rate of the metal bearing ore to the oscillating magnetic field is at least about 0.1 T/kg/min.

2. The method according to claim 1, wherein the frequency of oscillation of the oscillating magnetic field is about 0.1 MHz to about 1 MHz.

3. The method according to claim 2, wherein the frequency of oscillation of the oscillating magnetic field is about 200 to about 400 kHz.

4. The method according to claim 3, wherein the frequency of oscillation of the oscillating magnetic field is about 330 kHz.

5. The method according to claim 1, wherein the oscillating magnetic field is generated by an alternating current.

6. The method according to claim 1, wherein the method further comprises crushing the metal bearing ore prior to exposing the metal bearing ore to the oscillating magnetic field.

7. The method according to claim 1, wherein the metal of the metal bearing ore comprises gold.

8. An apparatus for increasing the porosity of a metal bearing ore, the apparatus comprising:
a magnetic field source configured to generate an oscillating magnetic field at a frequency of oscillation of greater than about 0.1 MHz; and,
a conveyor adapted to transport the metal bearing ore through the oscillating magnetic field;
wherein the magnetic field source and the conveyor are adapted to expose the metal bearing ore to the oscillating magnetic field at a rate of at least about 0.1 T/kg/min.

9. The apparatus according to claim 8, wherein the magnetic field source generates an magnetic field oscillating at about 0.1 MHz to about 1 MHz.

10. The apparatus according to claim 8, wherein the magnetic field source comprises at least one magnetic field generator.

11. The apparatus according to claim 10, wherein each of the magnetic field generators comprises a conductor connected to a power source, and wherein each of the power sources generates an alternating current flowing through the respective conductors to generate the oscillating magnetic field.

12. The apparatus according to claim 8, wherein the conveyor comprises a conveyor belt.

13. The apparatus according to claim 12, wherein the magnetic field generators are arranged linearly adjacent to the conveyor belt.

14. The apparatus according to claim 13, wherein at least a portion of each conductor is positioned beneath the conveyor belt.

15. The apparatus according to claim 13, wherein each conductor is in the form of a loop, and wherein the conveyor belt passes through the loops.

16. The apparatus according to claim 8, wherein the conveyor comprises a hollow conduit.

17. The apparatus according to claim 16, wherein the magnetic field generators are arranged longitudinally along at least a portion of the hollow conduit.

18. The apparatus according to claim 16, wherein each conductor is in the form of a loop positioned around at least a portion of the outer surface of the conduit.

19. The apparatus according to claim 16, wherein the hollow conduit includes a means for preventing blockage of the metal bearing ore being transported therethrough.

20. The apparatus according to claim 19, wherein the means for preventing blockage comprises a mandrel axially positioned within the conduit.

21. The apparatus according to claim 20, wherein the mandrel is adapted to move within the conduit.

22. The apparatus according to claim 21, wherein the mandrel is moveable within the conduit in an axial direction.
